(19) United States
(12) Patent Application Publication
(10) Pub. No.: US 2020/0196587 A1
(43) Pub. Date: Jun. 25, 2020

(54) MOSQUITO ATTRACTING DEVICE AND SYSTEM USING THE SAME

(71) Applicant: MAXTECH MOSQUITO CONTROL INC., Waterloo (CA)

(72) Inventors: Mark Smith, Kitchener (CA); Kailash Vasudeva, Waterloo (CA)

(21) Appl. No.: 16/612,600

(22) PCT Filed: May 9, 2018
(86) PCT No.: PCT/CA2018/050551

§ 371 Date: Nov. 11, 2019

Related U.S. Application Data
(60) Provisional application No. 62/503,415, filed on May 9, 2017.

(30) Foreign Application Priority Data
May 10, 2017 (CA) 2,966,262

(51) Int. Cl. A01M 1/02; A01M 1/10

(52) U.S. Cl. CPC A01M 1/023; A01M 2200/012; A01M 1/106

(57) ABSTRACT

Disclosed is a capture device for attracting and trapping mosquitoes comprising a sound emitter, a distress cancelling emitter for use in a mosquito trapping device for minimizing or eliminating distress signals given off by trapped mosquitoes from exiting the device. A system for minimizing mosquito populations and infestation in an area comprising: an apparatus for attracting disease-carrying female gravid mosquitoes that can trap the mosquitoes and capture/destroy the eggs released from such mosquitoes, a capture device that emits a sound that attracts male mosquitoes and a means for instantly killing the captured mosquitoes.

### FIELD OF THE INVENTION

Generally, the present invention is directed to pest control systems. More specifically, the present invention is directed to devices and systems for attracting mosquitoes.

### BACKGROUND OF THE INVENTION

Mosquitoes are a menace in general for their annoying bites and pose a health threat in that they are responsible for spreading diseases like malaria, dengue, West Nile fever, chikungunya, yellow fever, Zika fever, etc. On one hand, scientists continue research to find cures for these diseases and on the other hand, research-based methods are being applied to contain and eradicate mosquitoes.

The marketplace is flooded with consumer products that promise to trap and kill mosquitoes. The majority of these products are generally effective for trapping flying insects; however, they are barely effective in trapping and killing mosquitoes. Some of the high-end products are partially effective in trapping and destroying mosquitoes. It is of utmost importance to have a thorough behavioural knowledge of the various species of mosquitoes in order to invent effective means/devices to trap and destroy mosquitoes.

The annoying biting mosquitoes are females that need human blood to nourish eggs in their bodies until they are ready to lay the eggs in a suitable environment. The products available to trap, kill or repel mosquitoes are targeted for females only. Male mosquitoes are not an annoyance to humans but are responsible for mating with females and instrumental in the enhancement of the mosquito population. Hence, methods need to be developed to attract, trap and kill male mosquitoes. Unlike female mosquitoes, the males are not lured by body heat, CO₂ or body odour.

Keeping in mind the behaviour of mosquitoes in general and that of different species of mosquitoes in particular, it is difficult to come up with a universal trapping device. Some species of female mosquitoes lay their eggs on water surfaces while others lay eggs on plant leaves. Further, also considering the behaviour of male and female mosquitoes, the triggers used by each sex to reach their target are very different. Therefore, a common lure or attractant is very difficult to envision. Further, the regional climates, temperatures and humidity levels also influence the functional aspects of trapping devices.

### SUMMARY OF THE INVENTION

According to an aspect of the present invention, there is provided a sound emitting device for attracting and trapping male mosquitoes. In one preferred embodiment, the device is capable of producing a sound in the frequency range of 200-800 Hz with a low level variable acoustic harmonic.

In one embodiment, the device has a sound producing system running on a low power battery source or is solar powered.

According to a second aspect of the present invention, there is provided a distress cancelling emitter for use in a mosquito trapping device. The distress cancelling emitter minimizes or eliminates distress signals given off by trapped mosquitoes from exiting the device. The distress cancelling features can include, but are not limited to, sound or smell neutralizing/dampening features.

According to a third aspect of the present invention, there is provided a system for minimizing flying insect populations and infiltration in an area. The system includes: an apparatus for attracting female gravid mosquitoes that is capable of trapping the mosquitoes and/or the eggs released from such mosquitoes; and, a capture device that emits a sound that attracts male mosquitoes. The apparatus for attracting female gravid mosquitoes can include multiple mosquito attractant or luring features, whereas both the apparatus for attracting female gravid mosquitoes and the capture device can include distress cancelling emitters for minimizing or eliminating distress signals given off by trapped mosquitoes from exiting either the apparatus or device.

### BRIEF DESCRIPTION OF THE DRAWINGS

These and other features, aspects and advantages of the present invention will become better understood with regard to the following description and accompanying drawings wherein:

FIG. 1 represents a capture device comprising a sound emitter for attracting and trapping male mosquitoes according to an embodiment of the present invention;

FIG. 2 represents a capture device comprising a sound emitter for attracting and trapping male mosquitoes according to an embodiment of the present invention;

FIG. 3 represents a low-power capture device comprising a sound emitter for attracting and trapping male mosquitoes according to an embodiment of the present invention;

FIGS. 4A-4B represent a standalone capture device comprising a sound emitter for attracting and trapping male mosquitoes according to an embodiment of the present invention;

FIGS. 5A-5C represent a standalone capture device comprising a sound emitter for attracting and trapping male mosquitoes according to an embodiment of the present invention;

FIGS. 6A-6C represent a standalone capture device comprising a sound emitter for attracting and trapping male mosquitoes according to an embodiment of the present invention;

FIG. 7 represents a sample layout of a system according to an embodiment of the present invention.

### DESCRIPTION OF THE INVENTION

The following description is of an illustrative embodiment by way of example only and without limitation to the combination of features necessary for carrying the invention into effect.

According to an aspect of the present invention, there is provided a capture device for attracting and trapping male mosquitoes comprising a sound emitter. The sound emitter emulates the flight tone produced by female mosquitoes inviting male mosquitoes for mating. Female mosquitoes are also attracted by a pack, heard, gathering or grouping scenario to the lower wavelengths of the harmonics produced by the sound emitter.

In one preferred embodiment, the sound emitter produces a sound in the frequency range of 200-800 Hz. In one embodiment, the sound is produced by sine waves with a low level variable acoustic harmonic. In a further embodiment, the frequency range is 200-500 Hz. In an even further embodiment, the frequency range is 300-400 Hz.

Different mosquito species produce different flight tones. In a controlled laboratory environment, the sound from young female mosquitoes raised in the lab was captured. In this environment, it was possible to source first flight females and capture the sounds of their flight tones using high intensity recording devices. The captured sounds were tested in the lab in two separate arenas. The captured sounds were played back in arena A and in arena B, in which were placed various genus of mosquitoes. Based on the results of these tests, it was possible to isolate the frequency to which each type of mosquito responded best. Thus, in order to capture these different species, the sound emitter may produce more than one frequency. Therefore, in a further embodiment, the sound emitter cycles between two or more frequencies. In one example that is not meant to be limiting, the sound emitter cycles between the frequencies 200, 300, 400, 500, 600, 700 and 800 Hz. In a further example that is not meant to be limiting, the sound emitter cycles between the frequencies 200, 250, 300, 350, 400, 450 and 500 Hz. In a further example that is not meant to be limiting, the sound emitter cycles between the frequencies 320, 340, 360, 380 and 400 Hz. Each frequency may be maintained for any period of time, for example at least 10, 20, 30, 40, 50, 60, 70, 80, or 90 seconds. In one embodiment, each frequency is maintained for about 60 seconds.

The sound emitter may be any device that produces the desired sound or sounds, which will be known to a person skilled in the art. The sound emitter may use the power source of the capture device or may use its own power source.

The sound emitter may be located in the vicinity of the capture device, preferably beside the capture device or more preferably, integral to the capture device to mimic female mosquitoes trapped inside.

The device can be provided in a number of configurations, such as one that is hardwired or plugged, directly or indirectly (i.e. through an extension cord) into an electrical receptacle. Another possible embodiment is one that is a portable/standalone unit that can be powered by battery or solar power. A further embodiment comprises a portable/standalone unit that is charged while being attached to a main unit, which may comprise a mosquito trapping device itself. In this embodiment, the portable/standalone unit may comprise rechargeable batteries. The rechargeable batteries may be charged by driving the suction fan of the portable/standalone unit by air flow created by the main unit suction fan.

In a further embodiment of the capture device, the capture device comprises a suction fan and a collector tray, wherein the suction fan captures the mosquitoes and drives them toward the collector tray, as will be described below.

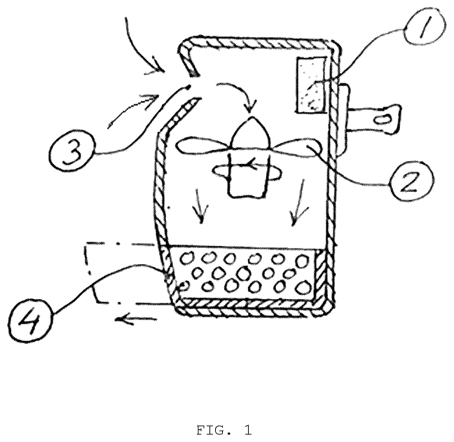

In one embodiment as shown in FIG. 1, the device is designed to be directly connected into an outdoor receptacle. For example, the capture device may be mounted on a wall of a building. The capture device has a sound emitter (1), a suction/chopping fan (2), a window as suction funnel (3) and a removable perforated collector (4) to collect killed mosquitoes. The mosquitoes are lured to the device by means of at least the sound emitter and enter the window (3). The suction fan (2) creates suction pressure to drive the mosquitoes into the removable perforated collector tray (4). The mosquitoes are either mulched, smashed, crushed or chopped by the suction fan (2) or they dehydrate or starve in the removable perforated tray (4).

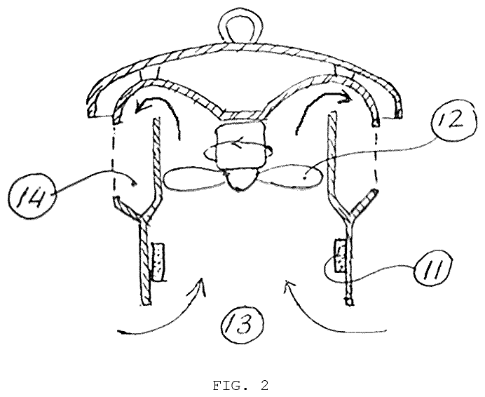

In another embodiment as shown in FIG. 2, the device can be hung, placed on a stand, or pillar mounted. The device has a sound emitter (11), a suction fan (12), a suction window (13) and a mosquito collection basket (14). In this embodiment, the device can be provided with an extension cord connected to an outdoor receptacle or with an AC to DC adaptor.

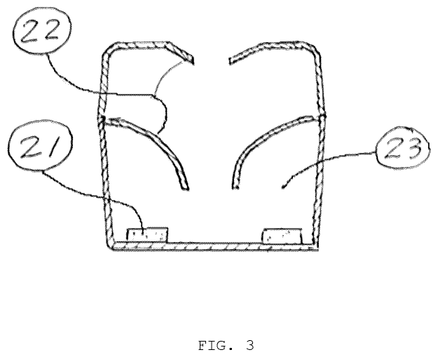

In a further embodiment as shown in FIG. 3, the device can be run on low power and is ideal for applications at remote areas where electrical power is scarce. The device can have a sound emitter (21), a funnel opening (22) and a trap box (23). The unit can be battery powered or solar powered.

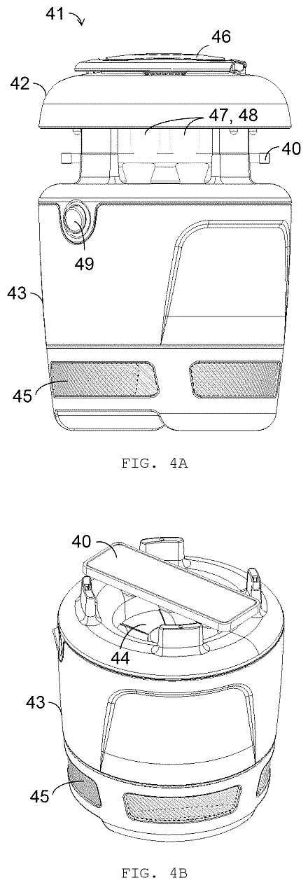

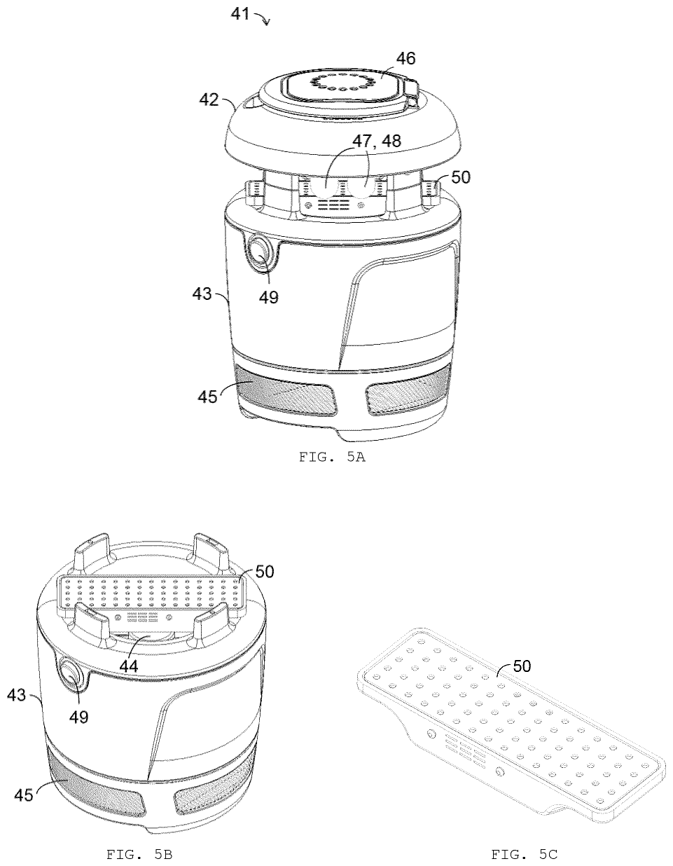

Further embodiments of the capture device are shown in FIGS. 4A to 6C. In these embodiments, the capture device (41) comprises a removable top portion (42) and a bottom portion (43), a suction fan (44), a removable perforated collector (45), a sound emitter (46) and an on/off switch (49). In FIG. 4B, the plate (40), mounted above the suction fan (44), is a smart device to monitor mosquito count, mosquito species, mosquito gender, and time when captured over a period of time. The smart device could also communicate with a smart phone or a monitoring centre. In FIGS. 5A to 5C, the plate (50) is used as a cage or a trapping system to keep the mosquitoes alive for research or other uses.

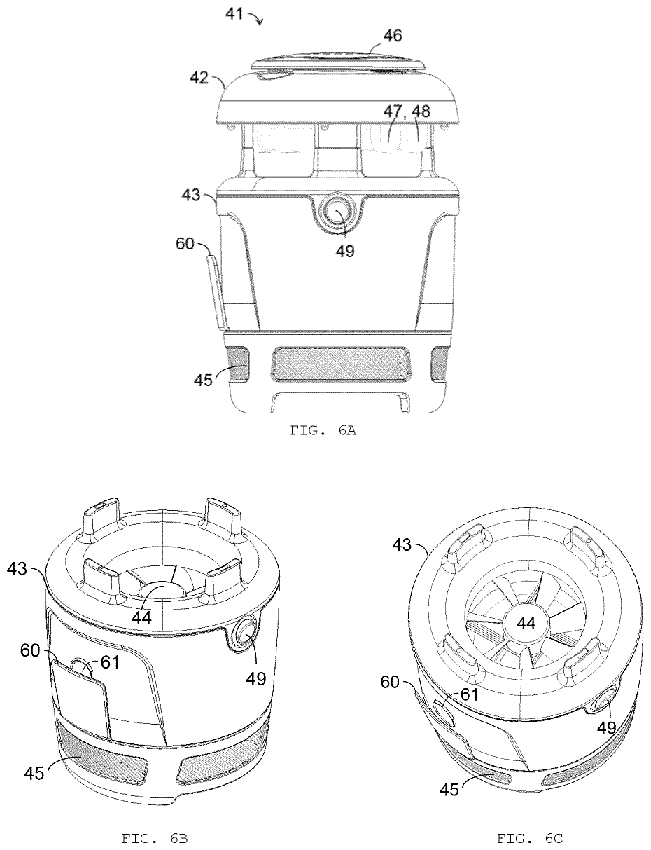

The embodiment of the capture device in FIGS. 6A to 6C comprises a trap door (60) and trap door opening (61). This allows the additional capture of mosquitoes.

In another embodiment of the present invention, the capture device comprises at least one electrified wire mesh. Devices with electrified wire meshes are typically known in the art as ‘bug zappers’. As a bug enters the electrified wire mesh, it completes the electric circuit and is killed.

In a further embodiment of the present invention, the capture device may comprise one or more mosquito attractant or luring features, such as a food smell (sugar nectar) and/or a holographic illusion of female mosquitoes used to attract male mosquitoes. Other mosquito attractant or luring features include, without limitation, a UV light, an IR LED lamp, a heat source, a CO₂ source, synthetic attractants compositions (such as described in WO2014/113876, which is incorporated herein by reference), octenol source or derivatives thereof, or a combination thereof.

For example, FIGS. 4A to 6C show a UV light (47) facing outwards to draw mosquitoes towards the device. The UV light may also provide a heat source (48) to mimic the appearance of a food source for the mosquitoes. The UV light or heat source (47, 48) may pulse to mimic a food source that is moving. The heat source may (48) be also be provided by any other means. CO₂ and octenol or derivatives thereof may also be provided by any means known in the art.

Any other mosquito attractant or luring feature is contemplated to be used with the capture device.

The mosquitoes attracted and trapped for destruction by any of the described methods might not die instantly. Thus, these dying mosquitoes send out distress/danger signals by audio and/or odor to their community about impending danger. The capture device will therefore lose efficiency over a period of time. It is thus necessary to mitigate or neutralize these signals either by sound neutralizing/dampening, smell dampening/neutralizing or other suitable methods.

Therefore, according to a second aspect of the present invention, there is provided a distress cancelling emitter for use in a mosquito trapping device. The distress cancelling emitter minimizes or eliminates distress signals given off by trapped mosquitoes from exiting the device. The distress cancelling features can include, but are not limited to, sound or smell neutralizing/dampening features. Sound dampening is the means of producing multiple frequencies in separate rates, intensities tones, pitches, similar audio adjustment. Smell neutralizing is a means by which multiple scents are stacked or emitted at the same time as the distress emission, thus camouflaging the base scents given off by a trapped mosquito.

In one embodiment of the capture device described above and throughout, the capture device comprises the distress cancelling emitter described above for minimizing or eliminating distress signals given off by trapped mosquitoes from exiting the capture device.

In a further embodiment of the present invention, the collector trap of the capture device comprises a UV light for killing captured mosquitoes and/or disease-causing agents carried by the mosquitoes. Mosquitoes may carry viruses, bacteria, parasites or other agents that can be transmitted to humans and cause diseases in humans, for example, and without limitation, malaria, dengue, West Nile fever, chikungunya, yellow fever, filariasis, tularemia, dirofilariasis, Japanese encephalitis, Saint Louis encephalitis, Western equine encephalitis, Eastern equine encephalitis, Venezuelan equine encephalitis, Ross River fever, Barmah Forest fever, La Crosse encephalitis, and Zika fever. It is important to destroy the agents that transmit these diseases, or the mosquito that carries these diseases. The UV light may be located within the collector trap of the capture device, so that mosquitoes captured by the suction fan are exposed to the UV light when entering the collector trap.

According to another aspect of the present invention, there is provided a system for minimizing flying insect populations and infiltration in an area. The system includes: an apparatus for attracting female gravid mosquitoes that is capable of trapping the mosquitoes and/or the eggs released from such mosquitoes; and a capture device that emits a sound that attracts male mosquitoes. The apparatus for attracting female gravid mosquitoes can include multiple mosquito attractant or luring features, whereas both the apparatus for attracting female gravid mosquitoes and the capture device can include distress cancelling emitters for minimizing or eliminating distress signals given off by trapped mosquitoes from exiting either the apparatus or device.

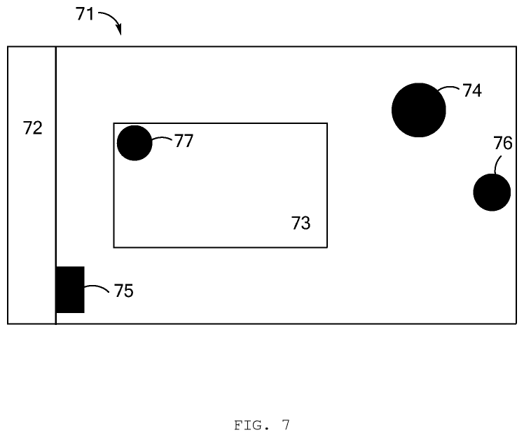

The system described herein provides an environment for trapping and destroying mosquitoes, or other flying insects, in a unit area (a backyard, for example). This will be achieved by using an appropriate combination of trapping devices placed at strategic locations in the backyard. FIG. 7 depicts one exemplary layout of the system.

The apparatus used in the system provides a suitable environment for different species of female mosquitoes to lay eggs. The mosquitoes with eggs or eggs alone are trapped in the apparatus and destroyed. One such apparatus is described in co-owned application WO2015/082700, the entirety of which is incorporated herein by reference.

The capture device used in the system comprises a sound emitter, as described above and throughout.

In a further embodiment of the system described above, the apparatus and/or capture device may include one or more mosquito attractant or luring features, such as a UV light, heat source, CO₂ source, synthetic attractant composition (such as described in WO2014/113876), octenol source or derivatives thereof, or a combination thereof.

In a further embodiment of the system described above, the apparatus and/or capture device may include the distress cancelling emitter as described above.

In a further embodiment of the system described above, the system may further include a smart device that attracts and kills flying insects. The smart device may, in certain embodiments, instantly kill the flying insects. In addition, the smart device may include a communications system for communicating with a smart phone to monitor and record count, gender, and/or species of the flying insects.

The system can also include multiple apparatuses or devices as described above to cover a larger area.

FIG. 7 shows an exemplary layout plan of a backyard (71) of a house (72) as an example. A similar pattern can be used proportionally for bigger or smaller areas. The exemplary layout includes:
1. an apparatus (74) for attracting disease-carrying female gravid mosquitoes that can trap the mosquitoes and/or the eggs released from such mosquitoes is placed in the middle of backyard (71);
2. a smart capture device (75) connected to an electrical receptacle box outside of the house (72) that communicates with a smart phone or central monitor station in order to keep count of mosquitoes and their characteristics as they are trapped and killed instantly.
3. optionally, a portable capture device (76) is placed at the far end of the backyard; and
4. additionally, an apparatus (77) for attracting male mosquitoes through a sound device, as well as disease-carrying female gravid mosquitoes, and which is capable of trapping and destroying said mosquitoes is placed on the deck (73) away from the area inhabited by humans.

The system works on the premise that there are three categories of mosquitoes in the backyard space:

(a) female mosquitoes ready to lay eggs;

(b) female mosquitoes looking for blood meal to nourish eggs; and

(c) male mosquitoes.

Category (a) mosquitoes find a suitable environment in the apparatus (74,77) to lay eggs, whereas category (b) mosquitoes, in search of human blood, detect attractant from the apparatus (74,77) or any other device (75,77) capable of the same functionality. The mosquitoes fly towards these apparatuses where they are eradicated. In the meantime, category (c) mosquitoes are being attracted by female sounds produced by the device (75) where they are trapped and ultimately killed. The male mosquitoes are also attracted by female sounds produced by the additional portable device (76) at the far end of the backyard where they become trapped in the device and are ultimately killed. In the trapping devices (75,76), the installed distress cancelling emitter combats the distress signals of trapped mosquitoes; therefore, more mosquitoes are eradicated.

The consequences of the process are that:
1. The eggs laid by different species of female mosquitoes are trapped and destroyed; therefore, no new mosquitoes are expected in the cluster;
2. The male mosquitoes are killed, and therefore cannot mate with the females, reducing the number of eggs; and
3. With the repetition of the above processes, the mosquito population decreases and, over a period of time, the mosquito population is drastically reduced.

Mosquitoes that enter from neighbouring or adjacent yards are attracted to attractants from the devices and are ultimately killed.

It will be understood that numerous modifications thereto will appear to those skilled in the art. Accordingly, the above description and accompanying drawings should be taken as illustrative of the invention and not in a limiting sense. It will further be understood that it is intended to cover any variations, uses, or adaptations of the invention following, in general, the principles of the invention and including such departures from the present disclosure as come within known or customary practice within the art to which the invention pertains and as may be applied to the essential features herein set forth, and as follows in the scope of the appended claims.

1. A capture device for attracting and trapping male mosquitoes comprising:
a sound emitter for producing sound patterns that mimic flight tones of female mosquitoes.

2. The capture device of claim 1, wherein the sound emitter produces a sound in the frequency range of 200-800 Hz.

3. The capture device of claim 2, wherein the frequency range is 200-500 Hz.

4. The capture device of claim 3, wherein the frequency range is 300-400 Hz.

5. The capture device of claim 1, wherein the sound emitter cycles between two or more frequencies.

6. The capture device of claim 5, wherein the two or more frequencies are 320, 340, 360, 380, 384 and 400 Hz.

7. The capture device of claim 5, wherein each frequency is maintained for about 60 seconds.

8. The capture device of claim 1, wherein the capture device is powered by a low power battery source or is solar powered.

9. The capture device of claim 1, wherein the capture device further comprises one or more mosquito attractant or luring features, wherein the attractant or luring features are food smell (sugar nectar) and/or a holographic illusion of female mosquitoes used to attract male mosquitoes.

10. A capture device that comprises one or more female mosquito attractants or luring features, wherein the attractants or luring features are UV light, IR LED lamps, heat source, CO₂ source, synthetic attractant composition, octenol source or derivatives thereof, or a combination thereof.

11. The capture device of claim 1, wherein the mosquitoes captured alive are treated for change of their genes to make them harmless and incapable of spreading diseases

12. The capture device of claim 1, wherein a smart device is installed to communicate with a smart phone or a monitoring station for monitoring and recording number of mosquitoes trapped, their species, gender and time of capture.

13. The capture device of claim 1, wherein the capture device further comprises a distress cancelling emitter for minimizing or eliminating distress signals given off by trapped mosquitoes from exiting the device.

14. The capture device of claim 13, wherein the distress cancelling emitter comprises sound or smell neutralizing/dampening features.

15. The capture device of claim 1, wherein the capture device further comprises a UV light for killing mosquitoes and/or disease-causing agents carried by the mosquitoes.

16.-17. (canceled)

18. A system for minimizing flying insect populations and infiltration in an area comprising:
an apparatus for attracting female gravid mosquitoes that is capable of trapping the mosquitoes and/or the eggs released from such mosquitoes; and
a capture device comprising a sound emitter that attracts male mosquitoes.

19. The system according to claim 18, further comprising a smart device that attracts and kills flying insects.

20. The system according to claim 19, wherein the smart device instantly kills said flying insects.

21. The system according to claim 19, wherein the smart device includes a communications system for communicating with a smart phone to monitor and record count, gender, and/or species of said flying insects.

22. The system of claim 18, wherein the apparatus and/or capture device comprise distress cancelling emitter for minimizing or eliminating distress signals given off by trapped mosquitoes from exiting the apparatus and/or device.
